(19) United States
(12) Patent Application Publication
(10) Pub. No.: US 2026/0336767 A1
(43) Pub. Date: Oct. 29, 2026

(54) METHOD FOR CONFIGURING FLOATING WIND SUBSTRUCTURE FOR LONG PERIOD WAVES

(71) Applicant: Jun Zou, Houston, TX (US)

(72) Inventor: Jun Zou, Houston, TX (US)

(21) Appl. No.: 19/187,612

(22) Filed: Apr. 23, 2025

(51) Int. Cl. B63B 35/44; B63B 21/50; F03D 13/25

(52) U.S. Cl. CPC B63B 35/44; B63B 21/502; F03D 13/256; B63B 2035/446; B63B 2231/04; B63B 2231/60; F05B 2240/93; F05B 2240/95

(57) ABSTRACT

This patent presents the design of floating wind substructures for offshore wind energy production, focusing on platforms located in areas with long-period waves. Three design alternatives are proposed to accommodate varying environmental and operational conditions, ensuring optimal structural efficiency, stability, and minimal steel weight. Each alternative is carefully tailored to achieve an ideal balance between performance and cost, making them suitable for diverse offshore environments. By optimizing both structural integrity and operational efficiency, the overall design offers a cost-effective solution for regions with long-period waves, ensuring high reliability and performance. This approach positions the design as a sustainable and efficient option for offshore wind projects in challenging wave conditions.

### FIELD AND BACKGROUND

The present invention pertains to the design of floating wind substructures for wind energy production, specifically focusing on the substructures of floating offshore wind turbine platforms installed in regions with long-period waves. For example, in 50-year design extreme sea states, the wave peak period exceeds 15.0 seconds.

Floating offshore wind turbine (FOWT) platforms have buoyant foundations that support towers topped with nacelles and blades. These platforms are designed to float on water and are anchored to the seabed, making them suitable for deeper waters where traditional fixed-bottom turbines are not feasible. Among the popular semi-submersible designs, FOWTs are categorized into two groups: one, where the Rotor-Nacelle Assembly (RNA) and tower are mounted on a column positioned away from the center of the substructure (FIG. 1), and another, where the RNA and tower are positioned at the center of the substructure, typically mounted on a central column (FIG. 2).

Recently, wind turbines have significantly increased in size to harness more energy and improve efficiency. For example, modern floating wind turbines can have a hub height of 150 meters (15 MW), with rotor blades extending up to 240 meters in diameter, enabling them to capture wind at higher altitudes and maximize energy production. Some planned wind farms in U.S. waters are in areas with long-period waves, such as the Gulf of Maine and offshore California, which are known for their unique wave characteristics. In extreme design sea states, such as a 50-year storm, the wave peak period in the Gulf of Maine can reach around 16 seconds, while offshore California can experience peak periods of approximately 20 seconds. These conditions pose significant challenges for semi-submersible types of floating substructures, requiring specialized design considerations to ensure the performance of the substructures, which must be suitable for both the wind turbine generators (WTGs) and power cables.

The conventional off-centered RNA/tower substructure (FIG. 1) faces several challenges in regions with long-period waves. To effectively increase the FOWT's heave natural period above the target values—19 seconds or higher for the Gulf of Maine and 23 seconds or higher for offshore California—it is essential to significantly enlarge the heave plates beneath the columns. This is nearly the only effective method for substantially increasing the heave added mass. However, this would lead to excessively large heave plates and support structures, making the design both impractical and cost prohibitive. A critical limitation lies in the inability of the underwater hull to adjust adequately to provide the necessary added mass to achieve the required heave natural period.

The conventional center-mounted RNA/tower substructure (FIG. 2) has several drawbacks in regions with long-period waves. Compared to the off-center substructure (FIG. 1), it includes an additional central column, which increases the waterplane area and hydrostatic heave stiffness. As a result, additional mass and added mass are required to offset the increased hydrostatic heave stiffness induced by the central column and achieve the desired heave natural periods. To meet these requirements, the pontoon widths would need to be significantly increased, resulting in an excessively large substructure. This would make the design both inefficient and costly. A key limitation is the inability of the underwater hull to effectively adjust and provide the added mass necessary to achieve the required heave natural period.

The cost of power generated by floating wind turbines is still approximately twice that of power generated by traditional methods. For the industry to become sustainable, it must address environmental challenges while significantly reducing overall project development costs. This invention is intended to respond to the market's needs and is designed to offer a simplified structure, accelerate construction, and enable rapid assembly and installation, with a hull adaptable to regions with long-period waves. Technology provides an alternative solution to optimize efficiency, reduce costs, and enhance the economic feasibility of development projects in such regions.

### SUMMARY OF THE INVENTION

The current embedment substructure, shown in FIG. 3A (a perspective view) and FIG. 3B (a bottom view) respectively, consists of the following components: 1) one tower transition, 2) one tower base, 3) three horizontally oriented tapered upper structure beams, 4) three horizontally oriented connection trusses, 5) three cross-connection trusses, 6) three inclined structural members, 7) three columns, 8) three base pontoons, 9) three inner support structure components, 10) three outer support structure components, 11) three connection pontoon beams, and 12) three cross-connection beams.

The tower transition connects at its top to the lower segment of the tower (not shown) and is located at the center of the substructure, extending slightly below the bottom of the tower base. The horizontally oriented tapered upper structure beams are attached at the inner end of the tower base at the same height, taper along a certain length, then maintain a constant height and connect to the tops of the columns at the outer end. The height of these beams decreases after a certain length from the inner end to reduce steel weight without sacrificing the efficiency of load transfer and mitigating potential wave slamming in extreme sea states. The three tapered upper structure beams are arranged at 120-degree angles to each other in the horizontal plane and are supported at their midpoints by three inclined structural members, as shown in FIG. 3A and FIG. 3B.

The three horizontally oriented connection trusses link the tops of the columns, tying them together, while the three cross-connection trusses connect the connection trusses at about one-quarter of their length to enhance the structure's rigidity and load sharing among the structural members. If the cross-connection trusses interfere with the inclined structural members, their connection points don't have to be at one-quarter of their length and shall be slightly adjusted to avoid interference, maintaining a gap of at least twice the diameter of the cross-connection truss. The columns are spaced according to stability requirements and are mounted atop the base pontoons.

The three inner support structure components connect the columns at one end, with their bottoms integrated into the tops of the base pontoons. The inner ends of these components, along with the base pontoons, form three inner walls that support the lower ends of the inclined structural members. Similarly, the three outer support structure components connect the columns at one end, with their bottoms also integrated into the tops of the base pontoons. The outer ends of these components, along with the base pontoons, form three outer walls that support the mooring hardware backup structures (not shown). The height of both the inner and outer support structure components is determined by the required height for the inclined structural members or the necessary clearance for the mooring hardware backup structures.

To complete the structure, three connection pontoon beams, aligned with the height of the base pontoons, connect the base pontoons. In addition, three cross-connection beams link the connection pontoon beams at approximately one-third of their length, enhancing the overall rigidity and aiding in the load distribution among the structural members, as shown in FIG. 3A and FIG. 3B.

The current embedment substructure is shown in FIG. 4A (elevation view) and FIG. 4B (top view from the mean water line). In FIG. 4A, the partial connection pontoon beam on the right side of the dashed line is intentionally omitted to emphasize the connection between the lower end of the inclined structural member and the inner wall formed by the inner support structure component and the base pontoon. Sufficient clearance is maintained between the keel of the substructure and the lowest point of the inclined structural member to avoid contact with the ground during both construction and transportation.

In FIG. 4B, the three columns are arranged in a triangular formation, each mounted on its respective base pontoon. The inner support structure components align with the corresponding outer support structure components through the columns, forming a robust framework capable of withstanding significant loads from the inclined structural members and mooring hardware back-up structures (not shown) during both pre-service and operational conditions. The three connection pontoon beams link the base pontoons, creating a triangular configuration. This structure is further reinforced by three cross-connection beams, which divide the larger triangle formed by the connection pontoon beams and base pontoons into three smaller triangles. This arrangement improves structural rigidity and load sharing among the members, enhancing overall structural performance.

As shown in FIG. 1 and FIG. 2, the limitations for regions with long-period waves are outlined in the previous description. The current embedded substructure, depicted in FIG. 3A, FIG. 3B, FIG. 4A, and FIG. 4B, features three base pontoons beneath each column. Three connection pontoon beams, each with a vertical cross-section in either rectangular or square shape, are placed between the base pontoons. Additionally, three cross-connection beams link two adjacent connection pontoon beams, enhancing the overall structural integrity. The dimensions of the base pontoons, connection pontoon beams, or a combination of both, can be adjusted to optimize the design for different regions with long-period waves. This flexibility allows the substructure to be tailored to specific environmental conditions, improving its performance in challenging wave environments.

To address the inefficiencies associated with the central column arrangement shown in FIG. 2, the current embedment substructure, as depicted in FIG. 3A, FIG. 3B, FIG. 4A and FIG. 4B, incorporates three inclined structural members. These members are connected at the top to the midpoints of three horizontally oriented tapered upper structure beams and at the bottom to three inner walls formed by the inner support structure components and base pontoons. The horizontally oriented upper structure beams are fixed at the inner end of the tower base and taper along a specific length before extending to the tops of the columns. Their height gradually decreases from the inner end, reducing steel usage, optimizing load transfer, and minimizing wave slamming impact.

This design improves load transfer efficiency by distributing the loads from the tower base across both the upper columns via the three tapped upper structure beams and the lower columns via the three inner walls formed by the inner support structure components and base pontoons. The waterplane area of the three inclined structural members is significantly smaller than that of the central column as described in the traditional layout shown in FIG. 2, thereby reducing its impact on the targeted heave natural period. Additionally, the inclined structural members are positioned away from the central substructure, increasing hydrostatic rotational stiffness and enhancing the overall stability of the substructure. These inclined structural members serve multiple functions, optimizing the structural arrangement by improving load distribution, increasing stability, enhancing overall structural efficiency, and reducing the negative impact on the heave natural period. As a result, the design becomes more adaptable and cost-effective for regions with long-period waves, ensuring better performance under various wave conditions.

The height of the base pontoons and connection pontoon beams is determined by several key factors, such as the maximum allowable draft at the quayside, the displacement under in-place conditions of the platform, and the structural strength and fatigue requirements of the structural components. These factors ensure the substructure's stability and performance, particularly in challenging marine environments. Furthermore, the height of the inner and outer support structure components is dictated by the required clearance for the inclined structural members or the height needed to accommodate the mooring hardware back-up structures.

Importantly, the heights of the inner and outer support structure components are independent of the height of the base pontoons and connection pontoon beams. This decoupling provides enhanced design flexibility, allowing the substructure's configuration to be optimized for maximum efficiency, stability, and performance. By decoupling these components, the weight of the substructure can be optimized, and the design can be precisely adapted to meet specific project requirements, improving both functionality and cost-effectiveness. This flexibility is crucial to ensure the system can effectively respond to a range of environmental and operational conditions with minimal costs.

The diameter of the base pontoon can be precisely engineered to provide optimal support for the inclined structural member, ensuring an efficient angle for load transfer from the tapered upper structure beam passing through the tower base. Additionally, the diameter of the base pontoon plays a crucial role in fine-tuning the heave natural period, which is a key design consideration. As previously discussed, the width of the connection pontoon beam is also an important design parameter for achieving the desired heave natural period. A careful balance can be struck between optimizing the base pontoon diameter for supporting the inclined structural member, adjusting it for the ideal heave natural period, and determining the optimal width for the connection pontoon beam. This trade-off allows for a well-balanced substructure, improving overall performance while minimizing hull steel weight.

Together, the tapered upper structure beam, inclined structural member, inner support structure component, base pontoon, and corresponding column form a cohesive and robust framework that provides both the necessary support and rigidity. This integrated structure is engineered to withstand the significant forces and moments generated by the wind turbine generator (WTG) and tower at the tower base, ensuring reliable performance and durability throughout their service life.

In certain design scenarios, proposed substructures may already provide sufficient buoyancy and stability but fail to achieve the desired heave natural period. One common solution is to increase the diameter of the base pontoons, the width of the connection pontoon beams, or both. However, this approach would result in an unnecessary increase in the substructure's steel weight. The current embedment design offers an alternative solution that meets the design objectives while minimizing the impact on the overall steel weight. As illustrated in FIG. 5A (a perspective view) and FIG. 5B (a top view from the mean water line), this method strikes a balance between optimizing the substructure's performance and keeping the increase in steel weight to a minimum.

The first step of this approach involves adding six connection plates between the base pontoons and the connection pontoon beams. These plates are positioned at the mid-depths of the base pontoons and connection pontoon beams, with their outer edge tangential to the base pontoons and intersecting the connection pontoon beams. This configuration enhances the strength of the connection while effectively increasing the heave added mass, which is crucial for adjusting the heave natural period.

If the additional mass from the first step is insufficient to achieve the desired heave natural period, the second step involves adding three additional connection plates between two adjacent connection pontoon beams and the base pontoon. These plates are placed at the mid-depths of the base pontoons and connection pontoon beams and feature an inner opening designed to avoid interference with the inclined structural members, as clearly displayed in FIG. 5B. The opening is formed by the cross-connection beam, the two adjacent connection pontoon beams, and the outer end of the connection plate between two adjacent connection pontoon beams and the base pontoon. The coverage of this opening can be adjusted from 0% (completely closed) to 100% (completely open) to meet the required heave natural period for specific regions with long-period waves. As shown in FIG. 5A and FIGS. 5B, 50% coverage is used as an example. This approach offers an efficient way to optimize the substructure's steel weight while achieving the desired heave natural period, particularly in regions with long-period waves.

In certain design scenarios, the proposed substructures may slightly fall short of providing the required buoyancy and achieving the desired heave natural period. One potential solution to this issue is to increase the diameter of the base pontoon, the width of the connection pontoon beam, or a combination of both. However, this approach would result in an unnecessary increase in the substructure's steel weight. The current embedment design offers a second alternative solution that effectively meets the design objectives while minimizing the increase in steel weight. As illustrated in FIG. 6A (a perspective view) and FIG. 6B (a top view from mean water line), this method optimizes the substructure design, improving performance without significantly adding to the overall steel weight.

This solution involves adding six connection structure components between the base pontoons and the connection pontoon beams. To highlight the additional structural components and the extra buoyancy they provide, dashed lines are included in FIG. 6B for clearer visibility. These components are integrated into the base pontoon and connection pontoon beam, maintaining the same height as the base pontoon and connection pontoon beam. Their outer edges are tangential to the base pontoon and intersect with the connection pontoon beams.

The connection structure components not only provide additional buoyancy, but they also strengthen the connection between the base pontoon and the connection pontoon beam. Furthermore, they effectively increase the heave added mass, allowing the desired heave natural period to be achieved with minimal increase in the substructure's steel weight. This approach ensures that the required performance standards are met while optimizing the design and keeping the overall steel weight to a minimum.

In certain design scenarios, the proposed substructures may fall short of providing the required buoyancy and may not meet the desired heave natural period. One possible solution is to increase the diameter of the base pontoons, the width of the connection pontoon beams, or a combination of both. However, this approach would lead to an unnecessary increase in the substructure's steel weight. The current embedment design offers a third alternative solution that meets the design targets, effectively satisfying the required performance criteria while minimizing the impact on overall steel weight. As shown in FIG. 7A (a perspective view) and FIG. 7B (a top view from the mean water line), this method optimizes the substructure's design, enhancing performance without significantly increasing its steel weight.

This solution builds upon the second alternative by introducing six connection structure components between the base pontoons and the connection pontoon beams. This addition helps achieve the required buoyancy and increases the added mass. To obtain the remaining required mass, a similar approach to the second step of the first alternative solution can be used by incorporating connection plates between two adjacent connection pontoon beams. In FIG. 7A and FIGS. 7B, 50% coverage is illustrated as an example, although this can be adjusted from 0% (completely open) to 100% (completely closed) to meet the remaining added mass requirements and fine-tune the heave natural period.

This strategy provides a viable solution for optimizing substructure steel weight while achieving the desired heave natural period, particularly in regions with long-period waves, such as offshore California. It ensures that the necessary buoyancy and heave natural period are met with minimal increase in the substructure's steel weight, offering a balanced and cost-effective design solution.

### BRIEF DESCRIPTION OF DRAWINGS

FIG. 1 displays an off-centered RNA/Tower three-column Semi-Submersible (Prior Art).

FIG. 2 illustrates a centered RNA/Tower four-column Semi-Submersible (Prior Art).

FIG. 3A depicts the present embodiment of the substructure—a perspective view.

FIG. 3B depicts the present embodiment of the substructure—a bottom view.

FIG. 4A presents the current embodiment of the substructure—an elevation view.

FIG. 4B presents the current embodiment of the substructure—a top view from the mean water line.

FIG. 5A displays the current embodiment of the first alternative configuration—a perspective view.

FIG. 5B displays the current embodiment of the first alternative configuration—a top view from the mean water line.

FIG. 6A illustrates the current embodiment of the second alternative configuration—a perspective view.

FIG. 6B illustrates the current embodiment of the second alternative configuration—a top view from the mean water line.

FIG. 7A depicts the current embodiment of the third alternative configuration—a perspective view.

FIG. 7B depicts the current embodiment of the third alternative configuration—a top view from the mean water line.

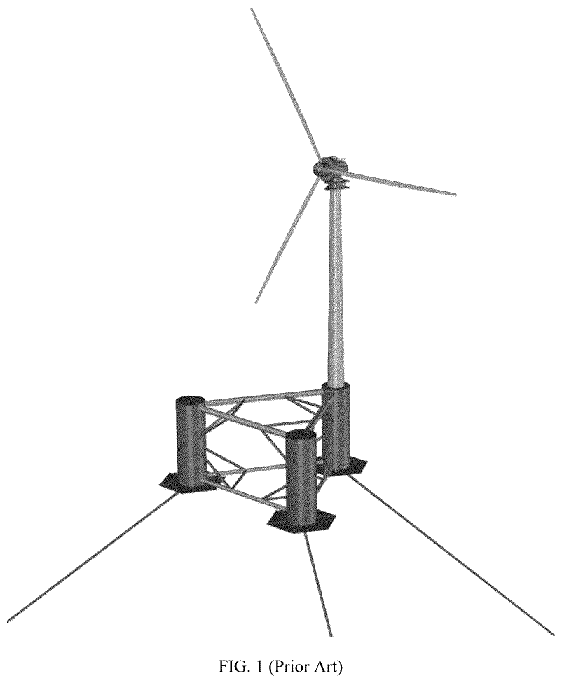

### DETAILED DESCRIPTION

A floating offshore wind turbine (FOWT) platform features a buoyant foundation that supports a tower, topped with a nacelle and blades. The platform is equipped with a mooring system to ensure seakeeping and dynamic cables to transmit wind-generated power to the grid. The design of the FOWT, including the RNA/tower, mooring system, and dynamic cables, is based on specified input data in accordance with the basis of design. The current embedment focuses on optimizing the configurations of the substructures, specifically tailored for deployment in regions with prevalent long-period waves, ensuring both optimal performance and minimized steel weight in challenging marine environments to significantly lower the Levelized Cost of Energy (LCOE).

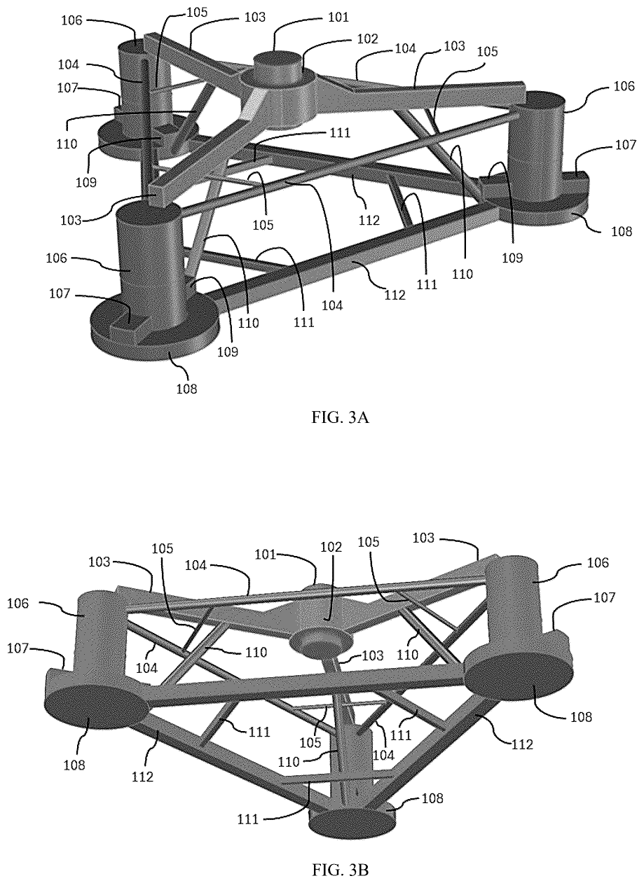

As shown in FIG. 3A (perspective view) and FIG. 3B (bottom view), the current embedment substructure consists of the following components: 1) one tower transition 101; 2) one tower base 102; 3) three horizontally oriented tapered upper structure beams 103; 4) three horizontally oriented connection trusses 104; 5) three cross-connection trusses 105; 6) three inclined structural members 110; 7) three columns 106; 8) three base pontoons 108; 9) three inner support structure components 107; 10) three outer support structure components 109; 11) three connection pontoon beams 112; and 12) three cross-connection beams 111.

The diameter of the tower transition 101 remains constant along its length and is positioned centrally within the substructure, connecting to the tower base 102 and extending slightly below its bottom. The diameter of tower transition 101 matches that of the lower tower segment (not shown), which will be specified as input data in the basis of design. The diameter of tower base 102 is determined by the diameter of the transition 101 and is also influenced by minimum operational and access requirements. The height of the tower base 102 is designed to meet both structural strength and fatigue criteria, ensuring it can withstand significant forces and moments transferred from the wind turbine generator (WTG) through the tall tower, while also accommodating storage needs.

The horizontally oriented tapered upper structure beams 103 are attached at the inner end to the base 102 and extend outward to connect with the tops of columns 106. These beams 103 are specifically configured to efficiently transfer and distribute loadings from the tower base 102 to the three columns 106, while minimizing steel usage and mitigating potential wave slamming in extreme sea states. At the inner end, beams 103 maintain the same height as the tower base 102, but taper down after a certain distance, maintaining a constant height as they connect to the tops of columns 106. The three tapered upper structure beams 103 are arranged at 120-degree intervals in the horizontal plane and are supported at their midpoints by three inclined structural members 110.

The three columns 106 are spaced in a triangular formation according to stability requirements and are mounted on top of the base pontoons 108. Three connection pontoon beams 112, each at the same height as the base pontoons 108, link the base pontoons 108 together, while three cross-connection beams 111 tie the connection pontoon beams 112 at one-third of their length into a cohesive structure. The combination of the three base pontoons 108 with the connection beams 112 forms a strong triangular framework. Additionally, a cross-connection beam 111 and two segments of adjacent connection pontoon beam 112 create smaller triangles, with a total of three small triangles within the larger triangular shape. This arrangement results in a rigid structural foundation at the lower end of the substructure.

At the upper end of the substructure, three horizontally oriented connection trusses 104 connect the tops of columns 106, securing them together and forming a strong and stable large triangle configuration. Meanwhile, three cross-connection truss 105 link the connection truss 104 to each other. A cross-connection truss 105 and two segments of adjacent connection trusses 104 at about one-quarter lengths form smaller triangles, creating a total of three small triangles within the larger triangular configuration. Like the arrangement at the lower end of the substructure, this arrangement ensures a rigid and stable structure at the upper end of the substructure.

Three inclined structural members 110 are connected at the top to the midpoints of three horizontally oriented tapered upper structure beams 103 and at the bottom to three inner walls formed by inner support structure components 109 and base pontoon 108. The tapered upper structure beams 103 are secured at one end to tower base 102 and at the other end to the tops of the corresponding columns 106. The inner support structure components 109 are connected at one end to the columns and integrated with the tops of the corresponding base pontoons 108.

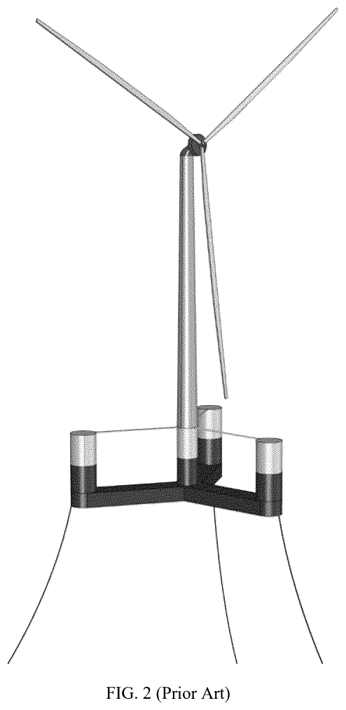

This arrangement improves load distribution efficiency by transferring forces and moments from the tower base 102 across the upper columns 106 through the tapered upper structure beams 103, and then to the lower columns 106 via the inner walls formed by inner support structure components 109 and base pontoons 108. The waterplane area of the inclined structural members 110 is significantly smaller than that of traditional central column support designs as presented in FIG. 2, reducing their impact on the targeted heave natural period. Additionally, positioning the inclined structural members 110 away from the central substructure increases hydrostatic rotational stiffness, enhancing overall stability. These inclined structural members 110 serve multiple functions, mitigating negative impact on heave natural period, optimizing the structural configuration for better efficiency, stability, and adaptability in a wide range of environmental conditions.

The three inner support structure components 109 connect the columns 106 at one end and the lower end of inclined structural members 110 at the other, with their bases integrated into the tops of the base pontoons 108. The inner end of these components 109, along with the base pontoons 108, forms three inner walls that support the inclined structural members 110. Similarly, the three outer support structure components 107 connect columns 106 at one end, with their bases also integrated into the tops of the base pontoons 108. The outer end of these components 107, along with the base pontoons 108, forms three outer walls that support the mooring hardware back up structures (not shown). This integration helps maintain the overall structural integrity of the system. The height of both the inner and outer support structure components (107 and 109) is determined by the required elevation for the inclined structural members 110 or the necessary clearance for the mooring hardware back-up structures (not shown), ensuring optimal functionality and safety. The height of the base pontoons 108 and connection pontoon beams 112 is determined by several factors, including the maximum allowable draft at the quayside, displacement under in-place conditions of the platform, and the structural strength and fatigue requirements of the structural components. Importantly, the height of the base pontoon 108 and the connection pontoon beam 112 are decoupled with the heights of the inner and outer support structure components (107 and 109). This decoupling allows for flexible adjustments, enabling the optimization of each component's height to achieve the most efficient structural design with minimal steel weight.

The partially horizontally oriented tapered upper structure beam 103, the inclined structural member 110, the inner support structure component 109, the base pontoon 108, and the column 106 together form a rigid frame in the vertical plane. There are three rigid frames in the vertical plane, spaced 120 degrees apart between two adjacent frames, capable of withstanding significant forces and moments from large wind turbine generators (WTGs) and tall towers via the tower base 102. As previously described, a rigid frame in the horizontal plane is arranged at the top of the columns, while another rigid frame in the horizontal plane is designed at the lower end of the substructure. The newly formed three rigid frames in the vertical plane are further integrated into the existing rigid structure, enhancing the overall structural integrity and rigidity in both the vertical and horizontal planes. This integration improves the efficiency of load transfer and sharing, leading to a more efficient overall structure and a reduction in the steel weight required for the entire substructure.

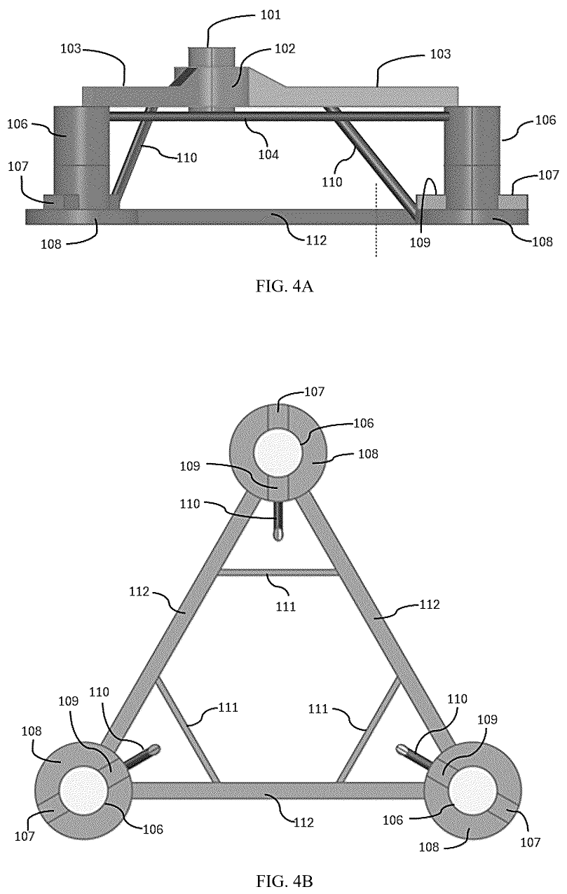

The current embedment substructure is depicted in FIG. 4A (elevation view) and FIG. 4B (top view from the mean waterline). In FIG. 4A, the partial connection pontoon beams 112 on the right side of the dashed line has been intentionally removed to highlight the connection between the lower end of the inclined structural member 110 and the inner wall formed by inner support structure component 109 and base pontoon 108. There is sufficient clearance between the keel of the substructure and the lowest point of the inclined structural member 110.

In FIG. 4B, the three columns 106 are arranged in a triangular configuration, with each column mounted on its respective base pontoon 108. The three inner support structure components 109 are aligned with the corresponding outer support structure components 107 via columns 106, creating a robust framework capable of withstanding the substantial loads from the inclined structural members 110 and the mooring hardware back-up structures (not shown), both during pre-service and in-service conditions. Three connection pontoon beams 112 link the base pontoons 108 in a triangular arrangement, which is further reinforced by three cross-connection beams 111 connected at one-third of the length of the connection pontoon beams 112. This reinforcement creates three smaller triangles within the larger triangle formed by the connection pontoon beams 112 and the base pontoons 108.

The diameter of the base pontoon 108 can be precisely engineered to provide optimal support for the inclined structural member 110, ensuring an efficient angle for load transfer from the tapered upper structure beam 103 passing from the tower base 102. Additionally, the diameter of the base pontoon 108 plays a crucial role in fine-tuning the heave natural period, which is a key design consideration. As previously discussed, the width of connection pontoon beams 112 also serves as an important design parameter for adjusting and achieving the desired heave natural period. A careful balance can be struck between optimizing the base pontoon 108 diameter for supporting the inclined structural member 110, adjusting it for the ideal heave natural period, and determining the optimal width for the connection pontoon beam 112. This trade-off allows for a well-balanced substructure, improving overall performance while minimizing hull steel weight.

Together, the tapered upper structure beam 103, inclined structural member 110, inner support structure component 107, base pontoon 108, and corresponding column 106 form a cohesive and robust framework that provides both the necessary support and rigidity. This integrated structure is engineered to withstand the significant forces and moments generated by the wind turbine generator (WTG) and tower via the tower base 102, ensuring reliable performance and durability throughout their service life.

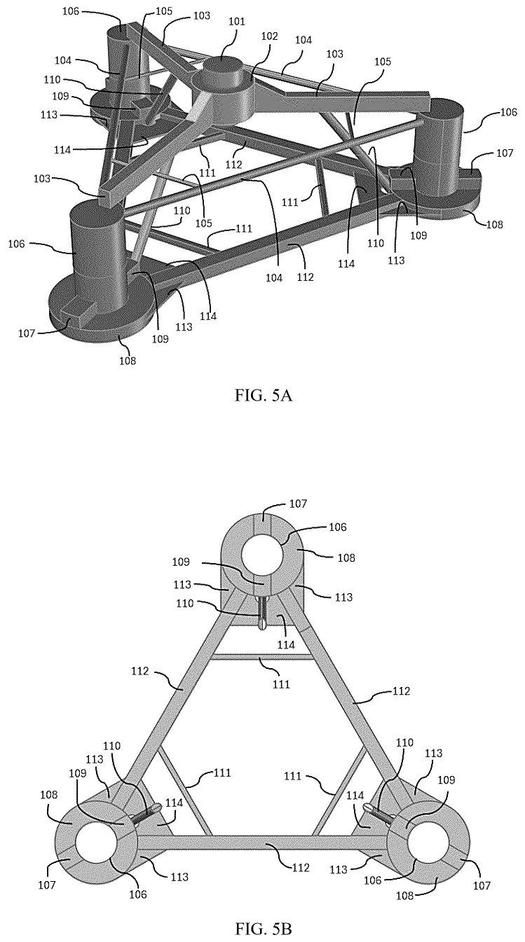

In some design cases, substructures provide adequate buoyancy and stability but fail to achieve the desired heave natural period. One approach to address this is by increasing the base pontoon 108 diameter or connection pontoon beam 112 widths or a combination of both. However, this would unnecessarily increase steel weight. The current embedded design, shown in FIG. 5A and FIG. 5B, offers the first alternative solution that meets performance criteria while minimizing steel weight.

The first step of this approach involves adding six connection plates 113 between the base pontoons 108 and the connection pontoon beams 112. These plates are positioned at the mid-depths of the base pontoons 108 and connection pontoon beams 112, with their outer edge tangential to the base pontoons 108 and intersecting the connection pontoon beams 112. This configuration enhances the strength of the connection while effectively increasing the heave added mass, which is crucial for adjusting the heave natural period. If the additional mass from the first step is insufficient to achieve the desired heave natural period, the second step involves adding three additional connection plates 114 between two adjacent connection pontoon beams 112 and the base pontoon 108. These plates are placed at the mid-depths of the base pontoons 108 and connection pontoon beams 112 and feature an inner opening designed to avoid interference with the inclined structural members 110. The opening is formed by the cross-connection beam 111, the two adjacent connection pontoon beams 112, and the outer end of the connection plate 114 between two adjacent connection pontoon beams 112 and the base pontoon 108. The coverage of this opening can be adjusted from 0% (completely closed) to 100% (completely open) to meet the required heave natural period for specific regions with long-period waves. As shown in FIG. 5A and FIGS. 5B, 50% coverage is used as an example. As shown in FIGS. 5B, 50% coverage is used as an example. This approach offers an efficient way to optimize the substructure's steel weight while achieving the desired heave natural period, particularly in regions with long-period waves.

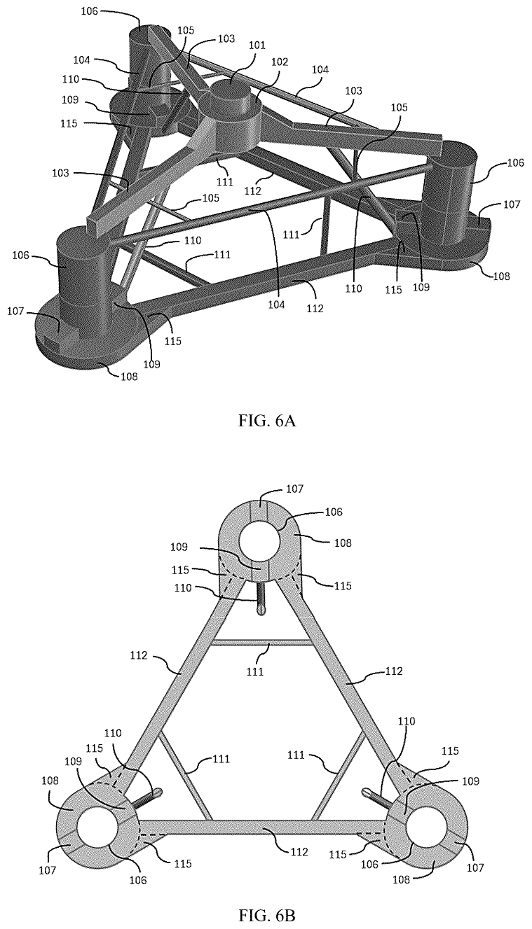

In certain design scenarios, the proposed substructures may fall short of providing the required buoyancy and achieving the desired heave natural period. One potential solution is to increase the diameter of the base pontoon 108, the width of the connection pontoon beams 112, or both. However, this would result in an unnecessary increase in the substructure's steel weight. The current embedment design offers the second alternative solution that effectively meets performance requirements while minimizing additional steel weight. As shown in FIG. 6A and FIG. 6B, this approach optimizes the substructure design, improving performance without substantially increasing overall steel weight.

The solution involves adding six connection structure components 115 between the base pontoons 108 and the connection pontoon beams 112. In FIG. 6B, dashed lines highlight these additional components and their contribution to buoyancy. These components are integrated seamlessly into base pontoon 108 and connection pontoon beam 112, maintaining the same height as both. Their outer edges are tangential to the base pontoon 108 and intersect with the connection beam 112. These connection components not only enhance buoyancy and strengthen the connection between the base pontoon 108 and connection pontoon beam 112, but they also effectively increase the heave added mass. This approach enables the desired buoyancy and heave natural period to be achieved with only a minimal increase in the substructure's steel weight, ensuring both structural efficiency and performance.

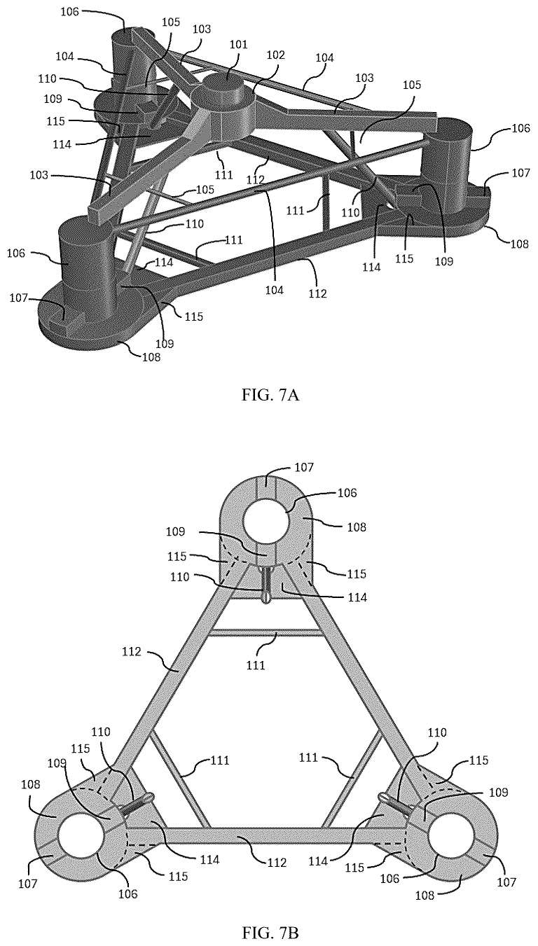

In some design scenarios, substructures may not provide sufficient buoyancy and achieve the desired heave natural period. One solution is to increase the base pontoon diameter 108 or connection pontoon beam width 112, but this would unnecessarily increase steel weight. The current embedded design offers a third alternative that meets performance criteria while minimizing steel weight. As shown in FIG. 7A and FIG. 7B, this approach enhances substructure design, improving performance without substantially adding to overall steel weight.

This solution adds six connection components 115 between the base pontoons 108 and connection pontoon beams 112, achieving the desired buoyancy and added mass. Any remaining added mass is added by incorporating connection plates 114 between adjacent connection pontoon beams 112, as shown in FIG. 7A and FIG. 7B with 50% coverage as an example. The amount of coverage of the opening as described above can be adjusted to fine-tune the heave natural period.

This method provides an efficient way to achieve the required buoyancy and heave response, particularly in regions with long-period waves, like offshore California, with minimal increase in substructure steel weight.

1. A floating wind substructure comprising:
one tower transition; and
one tower base; and
three horizontally oriented tapered upper structure beams; and
three horizontally oriented connection trusses; and
three cross-connection trusses; and
three inclined structural members; and
three columns; and
three base pontoons; and
three inner support structure components; and
three outer support structure components; and
three connection pontoon beams; and
three cross-connection beams.

2. The floating wind substructure of claim 1, the tower transition is positioned at the center of the substructure, with its upper end dimension matching that of the tower's lower segment, as input data specified in the basis of design. The lower end of the transition is mounted at the center of the tower base and extends slightly below it. The tower base maintains a constant cross-section along its height. The shape and dimensions of the cross-section, as well as the height of the base, are determined by the configuration of the tower transition, its operational function, and structural strength requirements. The tower base is connected to the inner ends of three horizontally oriented tapered upper structure beams, arranged radially with an angle of 120 degrees between adjacent beams. The height of the inner ends of these beams is consistent with the height of the tower base. The outer ends of the beams are supported by the tops of the corresponding columns.

3. The floating wind substructure of claim 1, wherein the tapered upper structure beam has a tapered configuration along its length, with the inner end having the same height as the tower base to effectively withstand the significant forces and moments generated by the high-capacity WTG and tall tower. The length and width of the tapered inner end of the beam are determined by structural strength requirements. Beyond the tapered segment, the remaining portion of the upper structure beam maintains a constant cross-section vertically. This tapered upper structure beam configuration provides adequate structural rigidity while optimizing the steel weight of the upper structure beam and mitigating potential wave slamming in extreme sea states.

4. The floating wind substructure of claim 1, wherein three columns are arranged in a triangular formation, based on stability requirements, and securely mounted on top of the base pontoons. These three base pontoons are interconnected by three connection pontoon beams, each positioned at the same height as the pontoons to ensure uniform structural alignment. Additionally, three cross-connection beams are incorporated to tie the connection pontoon beams together at one-third of the length of the connection pontoon beams, forming a cohesive and integrated structure. The combined arrangement of the three base pontoons and connection beams creates a strong and stable triangular framework that supports the columns in the horizontal plane. To further enhance the structural integrity and rigidity, each cross-connection beam, in conjunction with two adjacent connection pontoon beams, forms a smaller triangle. This results in a total of three smaller triangles, reinforcing the overall framework. This configuration provides a rigid and stable foundation at the lower end of the substructure in the horizontal plane, ensuring the stability, strength, and durability of the structural frame.

5. The floating wind substructure of claim 1, wherein, at the upper end of the substructure, three horizontally oriented connection trusses are employed to connect the tops of the columns, forming a secure triangular configuration. These trusses play a critical role in stabilizing the columns, ensuring they remain firmly anchored and properly aligned. To further enhance structural integrity and rigidity, three cross-connection trusses are incorporated, linking the connection trusses at about one-quarter of the length of the connection trusses to one another, thereby improving the overall cohesion and distribution of forces among the structural members. Each cross-connection truss, along with two segments of adjacent connection trusses, forms a small triangle, resulting in three smaller triangles nested within the larger triangular frame in the horizontal plane. This arrangement not only strengthens and stabilizes the upper end of the substructure but also ensures a rigid, reliable structure capable of efficiently withstanding the forces and moments exerted on it during operation.

6. The floating wind substructure of claim 1, wherein the tapered upper structure beam is supported at the midpoint of its length by the inclined structural member. The inclined structural member is positioned at its optimal angle, with its top located beneath the midpoint of the tapered upper structure beam and its bottom mounted on the inner wall formed by both the inner support structure component and the base pontoon. The lowest intersection point of the inclined structural member maintains adequate clearance from the keel of the base pontoon.

7. The floating wind substructure of claim 1, wherein the partially horizontally oriented tapered upper structure beam, the inclined structural member, the inner support structure component, the base pontoon, and the column collectively form a rigid frame in the vertical plane. There are three rigid frames in the vertical plane, spaced 120 degrees apart between two adjacent frames, capable of withstanding significant forces and moments from large wind turbine generators (WTGs) and tall towers via the tower base. As previously described, a rigid frame in the horizontal plane is positioned at the tops of the columns, while another rigid frame in the horizontal plane is designed at the lower end of the substructure. The newly created three rigid frames in the vertical plane are seamlessly integrated into the existing structure, significantly enhancing the overall structural integrity and rigidity. This integration optimizes the efficiency of load transfer and sharing throughout the entire substructure, resulting in a more effective design and leading to a reduction in the steel weight required for the entire substructure, improving both cost-effectiveness and sustainability without compromising structural performance.

8. The floating wind substructure of claim 1, wherein three inner support structure components connect the corresponding columns at one end, with their bases integrated into the tops of the base pontoons. The inner wall is formed by the inner end of the inner support structure component and the base pontoon, ensuring proper alignment and providing an adequate surface area for supporting the inclined structural members. Similarly, three outer support structure components connect the corresponding columns on the opposite side at one end, with their bases also integrated into the tops of the base pontoons. The outer wall is formed by the outer end of the outer support structure component and the base pontoon, providing sufficient surface area to accommodate the mooring hardware backup structures. The inner support structure components and outer support structure components are aligned via the columns with the same height, properly balancing the loads from the inclined structural members and mooring tensions. This configuration enables the substructure to withstand significant loads from the inner walls, which pass through the inclined structural members, as well as the outer walls, which are subjected to dynamic tension from the mooring hardware backup structures. The height of both the inner and outer support structure components is determined by the required elevation for the inclined structural members or the necessary clearance for the mooring hardware backup structures, ensuring optimal functionality, stability, and safety during operation.

9. The floating wind substructure of claim 1, wherein the height of the base pontoons and connection pontoon beams is determined by several factors, including the maximum allowable draft at the quayside, the displacement under in-place conditions of the platform, and the structural strength and fatigue requirements of the structural components. As previously mentioned, the height of the inner and outer support structure components is based on the required clearance for the inclined structural members or the necessary height to accommodate the mooring hardware backup structures. Notably, the height of the base pontoons and connection pontoon beams is independent of the heights of the inner and outer support structure components. This decoupling provides flexibility in the design, allowing for the optimization of each component's height to achieve an efficient and effective overall structural design with minimal steel.

10. The floating wind substructure of claim 1, wherein three base pontoons are positioned beneath each column, and three connection pontoon beams are arranged between two adjacent base pontoons. Additionally, three cross-connection beams are securely coupled to the two adjacent connection pontoon beams at one-third the length of the connection pontoon beams, further enhancing the structural rigidity. The dimensions of the base pontoons and connection pontoon beams can be adjusted in accordance with the specific characteristics of the site's metocean conditions. This adaptability allows the substructure to be optimized for the conditions of a designated site, particularly those subject to long-period waves, ensuring both superior performance and stability across a range of environmental conditions with minimal steel weight.

11. The floating wind substructure of claim 2, wherein the shape of the tower base may be cylindrical, a six-sided polygonal shape, or any other suitable form, depending on the specific design and site requirements. The tower base can be constructed from a variety of materials, including metal, concrete, or composites, allowing for flexibility in material selection to optimize strength, durability, and cost-effectiveness. Similarly, the tower transition section, which connects the tower to the substructure, can also be constructed from metal, concrete, or composites, offering further adaptability in material choices to meet the performance criteria and environmental conditions of the site. This versatility ensures that the substructure can be tailored for efficient and resilient operation in diverse conditions.

12. The floating wind substructure of claim 4, wherein the shape of the column and base pontoon may be cylindrical, a six-sided polygonal shape, or any other suitable form, depending on the specific design and site requirements. Similarly, the shape of the connection pontoon beam and cross connection beam may be rectangular, square, round, or any other appropriate shape. The connection pontoon beam and cross-connection beam can also be constructed from a variety of materials, including metal, concrete, or composites, offering flexibility in material selection to optimize strength, durability, and cost-efficiency based on the site conditions and performance requirements.

13. The floating wind substructure of claim 5, wherein the shape of the inclined structural member may be cylindrical, rectangular, square, or any other suitable form. The inclined structural member can be constructed from materials such as metal, concrete, or composites, allowing for flexibility in design and material selection to optimize strength, durability, and cost-effectiveness based on the specific requirements of the project.

14. A floating wind substructure comprising:
one tower transition; and
one tower base; and
three horizontally oriented tapered upper structure beams; and
three horizontally oriented connection trusses; and
three cross-connection trusses; and
three inclined structural members; and
three columns; and
three base pontoons; and
three inner support structure components; and
three outer support structure components; and
three connection pontoon beams; and
three cross-connection beams; and
six connection plates between base pontoons and connection pontoon beams; and
three connection plates among adjacent connection pontoon beams and base pontoons.

15. The floating wind substructure of claim 14, wherein six connection plates are added between the base pontoons and the connection pontoon beams, positioned at the mid-depth of the base pontoon and connection pontoon beam. The outer edge of each connection plate is tangential to the base pontoon and intersects with the connection pontoon beam. These connection plates serve to enhance the strength and stability of the connection between the base pontoon and the connection pontoon beam. Additionally, they effectively increase the heave added mass, which contributes to adjusting the heave natural period of the substructure, while minimizing the increase in substructure steel weight.

16. The floating wind substructure of claim 14, wherein three connection plates are added between adjacent connection pontoon beams and the base pontoons, positioned at the mid-depth of the base pontoon and connection pontoon beam. These connection plates feature an inner opening to prevent contact with the inclined structural members. An opening area is formed by the cross-connection beam, two adjacent connection pontoon beams, and the outer end of the connection plate between two adjacent connection pontoon beams and the base pontoon. The coverage of this opening is adjustable (0%, completely closed; 100%, completely open), based on the required heave natural period in regions with long-period waves. This adjustability enables optimization of the substructure's response to dynamic environmental conditions, thereby ensuring enhanced performance and minimal steel weight.

17. A floating wind substructure comprising:
one tower transition; and
one tower base; and
three horizontally oriented tapered upper structure beams; and
three horizontally oriented connection trusses; and
three cross-connection trusses; and
three inclined structural members; and
three columns; and
three base pontoons; and
three inner support structure components; and
three outer support structure components; and
three connection pontoon beams; and
three cross-connection beams; and
six connection structure components between base pontoons and connection pontoon beams.

18. The floating wind substructure of claim 17, wherein six connection structure components are created between the base pontoons and the connection pontoon beams. The outer edges of these components are tangential to the base pontoons and intersect the connection pontoon beams. These components are seamlessly integrated into both the base pontoon and the connection pontoon beam, maintaining the same height as both. These connection components not only enhance buoyancy and strengthen the connection between the base pontoon and the connection pontoon beam, but they also effectively increase the heave added mass. This design approach allows the desired buoyancy and heave natural period to be achieved with only a minimal increase in the substructure's steel weight, ensuring optimal structural efficiency and performance.

19. A floating wind substructure comprising:
one tower transition; and
one tower base; and
three horizontally oriented tapered upper structure beams; and
three horizontally oriented connection trusses; and
three cross-connection trusses; and
three inclined structural members; and
three columns; and
three base pontoons; and
three inner support structure components; and
three outer support structure components; and
three connection pontoon beams; and
three cross-connection beams; and
six connection structure components between base pontoons and connection pontoon beams; and
three connection plates among adjacent connection pontoon beams and base pontoons.

20. The floating wind substructure of claim 19, wherein six connection structure components are created between the base pontoons and connection pontoon beams, with their outer edges tangential to the base pontoons and intersecting the connection pontoon beams. These components are integrated seamlessly into both, maintaining the same height. Additionally, three connection plates are added at the mid-depth of the adjacent connection pontoon beams and the base pontoon, with inner openings to prevent contact with the inclined structural members. An opening is created between the cross-connection beam, two adjacent connection pontoon beams, and the outer end of the connection plate, positioned between the base pontoon and the connection pontoon beams. The size of this opening can be adjusted, ranging from 0% (completely closed) to 100% (completely open), depending on the required heave natural period for areas with long-period waves. This adjustability allows the substructure to be optimized for dynamic environmental conditions, enhancing its performance while minimizing the amount of steel required.
